(19) United States
(12) Patent Application Publication
(10) Pub. No.: US 2024/0343528 A1
(43) Pub. Date: Oct. 17, 2024

(54) Method for Operating a Crane, Indicator Element and a System

(71) Applicant: ABB Schweiz AG, Baden (CH)

(72) Inventors: Arne Wahrburg, Weiterstadt (DE); Silke Klose, Bensheim (DE); Janne Jurvanen, Espoo (FI); Matias Niemela, Helsinki (FI); Mikael Harry Holmberg, Porvoo (FI)

(73) Assignee: ABB Schweiz AG, Baden (CH)

(21) Appl. No.: 18/630,116

(22) Filed: Apr. 9, 2024

(30) Foreign Application Priority Data
Apr. 13, 2023 (EP) 23167822.8

(51) Int. Cl. B66C 13/46; B66C 13/06

(52) U.S. Cl. CPC B66C 13/46; B66C 13/063

(57) ABSTRACT

A method for operating a crane, comprising providing a crane with a jib element and an indicator element, wherein the jib element and the indicator element are arranged in a first position; moving the indicator element manually from the first position to a second position; triggering a movement of the jib element from the first position to the second position after the indicator element is arranged in the second position.

### CROSS-REFERENCE TO RELATED APPLICATIONS

The instant application claims priority to European Patent Application No. 23167822.8, filed Apr. 13, 2023, which is incorporated herein in its entirety by reference.

### FIELD OF THE DISCLOSURE

The present disclosure generally relates to a method for operating a crane and, more specifically, to an indicator element, a system with a tower crane or an overhead crane using said method and/or indicator element.

### BACKGROUND OF THE INVENTION

Cranes are relatively compliant mechanical structures. Especially when moving or when operating a crane in manual or any remote mode configuration, for example when rotating a jib element, this can result in notable oscillations if a human operator directly controls the speed of the motion with an input device. Several techniques exist to filter the user input of the operator such that the flexible modes of the crane are not excited. While this mitigates oscillations, the filtering can introduce significant delay to the user input, which makes the control system unintuitive and difficult to the operator. As a solution, the operator had to anticipate those input delays and had to adapt according to those input delays.

It has now become apparent, that there is a further need to provide a method for operating a crane.

### BRIEF SUMMARY OF THE INVENTION

In view of the above, the present disclosure generally describes a method for operating a crane, an indicator element, a system with a tower crane or an overhead crane using such a method.

According to a first aspect of the present disclosure, a method for operating a crane is provided, comprising the following steps: providing a crane with a jib element and an indicator element, wherein the jib element and the indicator element are arranged in a first position. Moving the indicator element from the first position to a second position. Moving the jib element from the first position to the second position, in particular after the indicator element is arranged in the second position.

### BRIEF DESCRIPTION OF THE SEVERAL VIEWS OF THE DRAWING(S)

The accompanying drawings, which are included to provide a further understanding of the invention and are incorporated in and constitute a part of this application, illustrate an embodiment of the invention and together with the description serve to explain the principle of the invention.

FIG. 1 is a schematic flow diagram of an embodiment of a method in accordance with the disclosure.

FIG. 2 is a schematic illustration of a system in accordance with the disclosure.

### DETAILED DESCRIPTION OF THE INVENTION

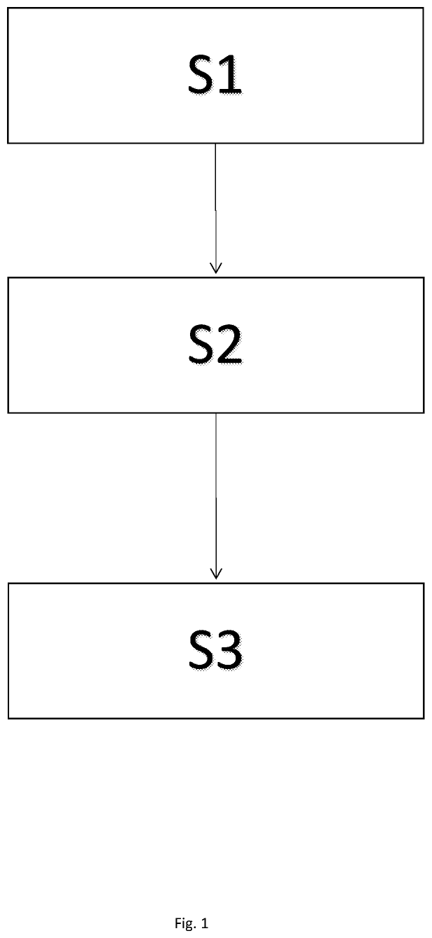

FIG. 1 shows an embodiment of a method for operating a crane. In a first step S1, a crane 10 with a jib element 11 and an indicator element 12 is provided. The jib element 11 and the indicator element 12 are arranged in a first position. The first position may also be described as a start position.

In the next step S2, the indicator element 11 is moved manually from the first position to a second position. The second position may also be described as end position.

In the next step S3, a movement of the jib element 11 from the first position to the second position is triggered after the indicator element 12 is arranged in the second position. The different steps may be executed in this order several times afterwards.

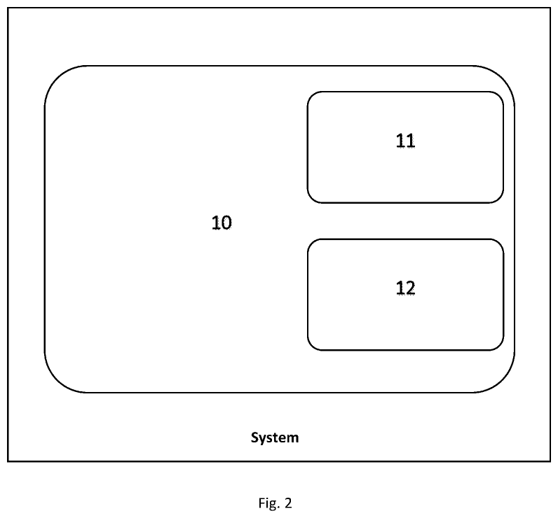

FIG. 2 illustrates a system. In the system, a method according to an embodiment of the present invention may be used. The system comprises a crane 10. The crane has a jib element 11 and an indicator element 12.

The term jib element 11 may be understood broadly. For example a jib element 11 may be moved in a linear or rotational manner. The jib element 11 which is connected to the object or mass to be transported or transferred.

The indicator element 12 may be designed as an indicator element 12 according to any of the embodiments described above.

The system may be configured to execute the method described beforehand or any other embodiment or combinations of embodiments described and disclosed in this application.

Any disclosure and embodiments described herein relate to the method for operating a crane and the system, lined out above or below and vice versa. The benefits provided by any of the embodiments and examples equally apply to all other embodiments and examples and vice versa.

It shall be noted that all embodiments of the present disclosure concerning the method might be carried out with the order of the steps as described. The herein presented method may be carried out with another order of the disclosed steps without departing from the respective method, unless explicitly mentioned to the contrary hereinafter. Furthermore, the features of the independent claims as well as their dependent claims may be combined with each other.

Other variations to the disclosed embodiments can be understood and effected by those skilled in the art in practicing the claimed invention, from the study of the drawings, the disclosure, and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

The crane may be of any type of cranes. The crane may be for example a construction/tower crane, indoor EOT overhead crane or harbor crane type cranes.

The jib element may be any element that needs to be aligned or moved to transport or transfer an object or a mass from the first position to the second position. The jib element is at least indirectly connected to the object or mass to be transported or to be transferred. The jib element may be for example a crane jib, an arm or a movable trolley. The movable trolley may be arranged on a crane jib or may be part of an overhead crane.

The indicator element may be a visual help to indicate the second position or desired end position of the jib element. The indicator element may also be parameter data, like a distance or an angle to a reference point.

The method according to the present invention allows the operator to control the indicator element. Once the indicator element has been positioned as desired, i.e. in the second position or the end position, the jib element moves to the second position in a control mode, with tailored controls making sure no oscillations occur. Thereby, cycle time reductions can be achieved, and the crane may be controlled easier by the operator. It may be possible that the jib element starts moving even though the indicator element is not yet in the second position.

Due to structural compliance, tower cranes can exhibit notable oscillations when rotating the jib element (slew motion). Even if an operator tries to gently ramp up the speed reference using an analog input device (e.g. a joystick), oscillations may occur. It needs a lot of skill and practice for an operator to implicitly learn the compliance of a crane and adapt the input to minimize oscillations. Therefore, the raw user input may be filtered. While such filtering can mitigate the excitation of flexible modes, it inevitably induces delay. Controlling a system with delays may be difficult. If you let go off the input device, it is naturally expected the crane to stop immediately. However, due to the filtering, the crane will keep moving for a while. Again, this unintuitive behavior needs time and practice to get used to. In a way, the problem is shifted from the operator implicitly having to learn the compliant mechanics of the crane to learning the time delays induced by the filtering. While the latter is considered easier, it still requires practice and results in a loss of performance because operators have to act conservatively (e.g. slowly approaching target position to prevent overshoot).

The method according to the present invention may be an assistive function. This means, the operator stays completely in charge of the crane motion. This means the method does not target any autonomous operation, hence perception and/or safety aspects are no concern. The method may speed up gross positioning of the crane, since optimized trajectory generation and position control may move faster without inducing oscillations compared to human operators, while still giving the operator control for manual fine positioning.

In an embodiment, the movement of the jib element from the first position to the second position is triggered manually or automatically. Additionally or alternatively, the movement of the indicator element from the first position to the second position is triggered manually or automatically.

In other words, the jib element may be controlled directly by the operator. Meaning the operator starts the movement of the jib element by manipulating for example a joystick or a similar control device. When manually triggering the movement of the jib element, the jib element and the indicator element preferably move simultaneously at least in partial areas of the movement. This allows the operator to see the second position or stop/end position of the jib element during its movement. The indicator element moves ahead of the jib element to the second position. More precisely, the indicator element may run ahead and the jib element may run behind. The second position of the indicator element is the position where the jib element would come to a standstill if the operator were to interrupt the movement at that time, for example by letting go of the joystick or set the speed reference to zero. In this case, the second position may also be described as dynamic second position. Due to the input filtering, the jib may not come to a stop immediately but may gently ramp down the speed.

Alternatively, the operator manually triggers the movement of the jib element, after the indicator element is in the second position. Additionally or alternatively, the jib element may be controlled by the operator in a manual mode. Based on a calculated motion profile, which may be generated after the indicator element is in the second position, a graphical display may be employed to visualize the ideal input. The graphical display may be for example shown on a monitor. This provides an assistive tool to the operator, as the operator is provided with an ideal trajectory to track.

Alternatively, the jib element may be moved automatically based on a calculated motion profile, which may be generated after the indicator element is in the second position. The automatic movement may trigger automatically or manually by the operator after the indicator element is in the second position. The second position may also be a dynamic position. This means, the jib element may start moving although the indicator element has not yet stopped.

In an embodiment, an acoustic or haptic feedback may be provided while moving the jib element. For a pre-programmed target position, an acoustic signal or haptic feedback via the joystick can be triggered once the operator is moving towards the target and the crane has reached the position from which the crane will converge to the desired target if the user lets go off the input device at the respective time instant. Furthermore, haptic queues in a force-feedback joystick may be employed, indicating if the operator is following the best possible input trajectory.

In an embodiment, the indicator element is part of the crane or connected to the crane. Preferably, the indicator element is movable, for example linear or rotatable, connected or arranged at the crane. The indicator element may be a constructive part. The indicator element may be a protruding element, for example a web element or a similar hardware element. The indicator element may also be described as a marker element or a pointer element. The indicator element is preferably identifiable or visible when operating the crane. At standstill, the indicator element is parallel to the jib element. While in motion, the indicator element moves ahead or away from the jib element. The indicator element will immediately come to a stop if the operator stops providing input. Next, the jib element follows the movement of the indicator element.

In an embodiment, the indicator element is a digital and/or virtual indicator element. In other words, the indicator element may be a graphic element, displayed on a monitor, for example of a tablet, or an augmented reality device. For example, a graphical display can show the same as the hardware indicator but as a virtual arrow pointing into the corresponding direction. When the indicator element is provided as a virtual overlay on a graphical display, the position of the real crane may be illustrated with an overlay showing the position of the crane at the predicted stop position. The indicator element may also be provided as a numerical display. This could be for example a simple textual display which may show the predicted extra distance for example in degrees.

In an embodiment, the indicator element is configured to be seen with an augmented reality device. The operator may use augmented reality glasses with an augmented reality overlay or a similar device to move the indicator device into the second position. More precisely, an operator wearing AR glasses, a virtual overlay of the crane at the predicted stopping position may be superimposed to the real-world view of the actual crane.

In an embodiment, the automatic movement of the jib element is a controlled movement. In an embodiment, the movement of the jib element comprises an anti-sway control and/or filtering, in particular notch-filtering and/or input shaping. Anti-sway typically refers to load sway. The other aspect is to prevent exciting oscillations of the mechanical structure of the crane. While filtering the input signals, a history of the user inputs is kept track of. Based on this, the idea is to pre-calculate at every time step where the crane would come to a rest, if the user would let go of the joystick, i.e. produce u (t≥T_i)=0.

In case of an abrupt change of speed reference to zero, position remains constant in an unfiltered case. However, such a speed reference profile is prone to significantly excite slew oscillations. The speed does not abruptly change to zero, but the speed references do so in ramped steps, which results in much less slew oscillations being excited. However, this results in unexpected extra travel distance.

For the special case of switching from maximum/constant speed to zero speed abruptly, the extra travel distance can easily be calculated analytically. In the general case (arbitrary user input, additional rate limiters, etc.), a solution can still be obtained by numerical integration. To this end, a simulation is run at each time step during runtime, piping the history of user inputs from the operator through the input filters and setting all future inputs to zero. The simulation runs until the predicted speed reference becomes zeros (this terminal or final time is known in advance if the filters have a finite time delay, which is the case for input filtering). This way, generic input filtering may be taken into account, including input shapers, notch filters, rate limiters, low-pass filters, etc. By numerical integration of the predicted filtered speed reference, the position of the crane at the end of the prediction is obtained. This corresponds to the stop position, i.e. second position. As the computation of the stop distance is computationally slim, it may be run online. If real-time execution requires, the sampling time of the simulation may be increased. This further speeds up computations at the cost of some loss of precision in the prediction.

Alternatively, the calculation of the final indicator stop position may also be done with a dynamic model which describes the dynamics of a speed-controlled ideally stiff tower crane. Hence, no structural compliances and no load sway are respected at all. This dynamic model is then fed with the unfiltered user input of the operator. Since the ideally stiff tower crane is speed-controlled and controller dynamics are much faster than tower crane dynamics, the actual slew and trolley positions match instantaneously with the corresponding manual speed references.

In an embodiment, the movement of the indicator element is a linear or a circular movement. For example the jib element may be of a tower crane or an overhead crane.

A further aspect of the present invention relates to an indicator element, configured for a use with a crane device, wherein the indicator element is configured to indicate the end position of a movement of a jib element.

A further aspect of the present invention relates to a system with tower crane or an overhead crane, using the method according to one of the embodiments above.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for operating a crane, comprising the following steps:
providing a crane with a jib element and an indicator element, wherein the jib element and the indicator element are arranged in a first position;
moving the indicator element from the first position to a second position;
moving the jib element from the first position to the second position after the indicator element is arranged in the second position.

2. The method according to claim 1, wherein the movement of the jib element from the first position to the second position is triggered manually or automatically.

3. The method according to claim 1, wherein the movement of the indicator element from the first position to the second position is triggered manually or automatically.

4. The method according to claim 1, wherein an acoustic or haptic feedback is provided while moving the jib element and/or the indicator element.

5. The method according to claim 1, wherein the indicator element is part of the crane and/or connected to the crane.

6. The method according to claim 1, wherein the indicator element is a digital and/or virtual indicator element.

7. The method according to claim 1, wherein the indicator element is configured to be visible with an augmented reality device.

8. The method according to claim 1, wherein the movement of the jib element is a controlled movement.

9. The method according to claim 1, wherein the movement of the jib element comprises an anti-sway control and/or filtering.

10. The method according to claim 1, wherein the movement of the indicator element is a linear or a circular movement.

11. An indicator element, configured for use with a crane device, wherein the indicator element is configured to indicate an end position of a movement of a jib element.
